(19) United States
(12) Patent Application Publication
(10) Pub. No.: US 2003/0208587 A1
(43) Pub. Date: Nov. 6, 2003

(54) Method of configuring and/or controlling an electronically controllable, modular facility

(76) Inventor: Martin Sauer, Marburg (DE)

Correspondence Address: FLYNN THIEL BOUTELL & TANIS, P.C., 2026 RAMBLING ROAD, KALAMAZOO, MI, 49008-1699, US

(21) Appl. No.: 10/426,406

(22) Filed: Apr. 30, 2003

(30) Foreign Application Priority Data
May 3, 2002 (EP) 02009940.4

(51) Int. Cl. G06F 15/173

(52) U.S. Cl. 709/223; 713/202

(57) ABSTRACT

The present invention relates to a method of configuring and/or controlling a modular facility (3), particularly for configuring (4) a server computer (3), the configuration being performed automatically and on the basis of at least one facility-specific script (7).

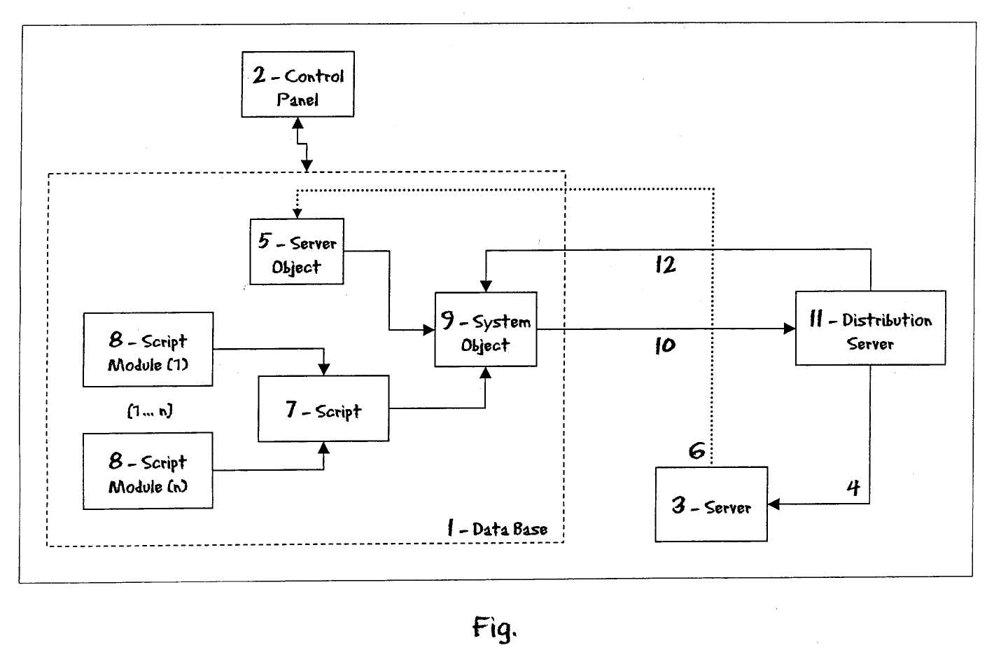

The method according to the present invention is distinguished in that the script (7) is generated automatically on the basis of information about the component and/or operating status of the facility (3). In this case, the information about the component and/or operating status of the facility (3) may be input manually, but may also particularly be determined automatically.

Thanks to the present invention, it is possible to centralize and automate the configuration, control, and maintenance of facilities, particularly the configuration and maintenance of complex, widely branched server networks. In particular, the outlay necessary for new configuration or reconfiguration of numerous server computers may be very decisively reduced thanks to the method according to the present invention.

The present invention relates to a method of configuring and/or controlling an electronically controllable, modular facility, particularly a server computer, according to the preamble of claim 1.

Methods of the type initially cited are particularly used where electronically controllable facilities are to receive a basic configuration or reconfiguration using automatic, preferably sequential execution of a number of facility-specific control commands and/or where such facilities are controlled partially or completely automatically.

The automatic execution of a series or sequence of individual commands is usually performed in practice in the form of a compiled command sequence or routine and/or in the form of a script containing a number of individual commands. In this case, it is primarily necessary that the script and/or the individual commands contained in a script are compatible in principle with the facility to be configured and/or controlled. In addition, these scripts and/or the individual commands or input data contained therein must be tailored to a possible special construction and/or special components of the facility in order to ensure faultless execution of the scripts and faultless functioning of the facility.

In addition, in the case of continuous control of a facility via one or more scripts, for example, the current operating status of the facility must be determined at regular intervals and possibly taken into consideration during the compilation and/or execution of the scripts.

In order to be able to correctly compile a facility-specific script and/or a script which takes the instantaneous operating status of the facility into consideration, it is therefore necessary that first information about the type of the facility and its components and/or about the operating status of the facility is established and that the particular appropriate script is then compiled from corresponding individual commands on the basis of this information. If, for example, there is additionally to be continuous control of the facility through one or more scripts, for example, it is necessary during the production of the script(s) used for this purpose also to take into consideration, in addition to the instantaneous operating status of the facility, an instantaneous intended state, which may deviate therefrom.

A facility of this type may be, though is not exclusively, a server computer, for example, via which data and/or services are to be made available in a network, for example. Server computers of this type are typically constructed modularly in order to be able to be tailored to client requirements. Even during the first and/or basic configuration of a modular server computer of this type, which is performed at the setup location by the user, numerous individual configuration steps are typically to be performed before the server computer may get into operation and take over the services provided in the network.

Examples of this are the hardware configuration, i.e., the harmonization of the individual components contained in the server computer with one another using appropriate setting of variables in the BIOS ROM of the server computer, for example, the fixing of the type of access of the server computer to storage media, such as magnetic disks (RAID configuration), or the installation and/or execution of operating system and possibly application components. It is thus clear that a basic configuration of a server computer of this type may certainly require the input of from several dozen to several hundred individual commands and/or server-specific input data.

If not only one single facility and/or one single server computer is to be configured, but this is necessary for multiple or even numerous identical or similar facilities present in a firm, compiling multiple or all of the commands and possibly input data necessary for configuration into a corresponding command sequence and/or a script, which may then be used for automatic configuration of any arbitrary number of essentially identical facilities and/or servers, is known in the related art for this purpose.

However, for the method known according to the species, it is always necessary for this purpose to first manually perform the configuration of a specimen facility representative of all facilities and/or servers to be configured and to log this specimen configuration and/or generate a corresponding image of this specimen configuration. A command script is then generated using the information contained in the log and/or image of this specimen configuration, also manually, using which the other facilities may finally be automatically configured. In this case, both the first necessary manual configuration of the specimen facility and the subsequent compilation of the configuration script, which is also performed manually, are labor-intensive and therefore cost-intensive. Furthermore, due to the numerous single steps necessary for such a configuration, there is always the danger of oversights; in addition, the quality of configuration scripts generated in this way is always highly dependent on the skill and experience of the person producing them.

If a faulty configuration script is produced in this way, then the deficiencies and/or faults contained therein are, of course, inherited by all of the facilities later configured using this script. A further essential disadvantage of the known method according to the species is, however, that a complicated configuration script generated manually using this method is only suitable for configuring identical or at least highly similarly constructed facilities, since the commands and/or setting data contained therein are only able to take the components contained in the specimen facility into consideration. This means that to configure further facilities, which deviate only slightly from the original specimen facility, a configuration script suitable for this differing facility configuration must again be generated in a costly way, which again requires the numerous manual steps described.

With this background, it is the object of the present invention to provide a method of configuring and/or controlling an electronically controllable, modular facility, a server computer, for example, using a facility-specific script, which overcomes the disadvantages cited above, and using which the manual outlay for configuring and/or controlling multiple different facilities may in particular be very significantly reduced.

This object is achieved by a method having the features of claim 1.

Preferred embodiments of the present invention are the object of the subclaims.

The method of configuring and/or controlling a facility is performed in this case in a way initially known per se on the basis of automatic execution of a facility-specific script, the execution of multiple configuration commands and possibly the input of facility-specific setting data being performed automatically.

However, the method according to the present invention is distinguished in that the facility-specific configuration and/or control script is generated automatically on the basis of information about the type and component construction of the facility and/or on the basis of information about the instantaneous operating status of the facility and on the basis of an intended state possibly deviating therefrom.

Therefore, even the necessity of initially configuring a specimen facility manually and in turn deriving the configuration script manually from this manual specimen configuration in order to generate a configuration and/or control script is primarily dispensed with.

In other words, thanks to the present invention, the configuration script may be generated, in contrast to the “manual-analog” procedure from the related art, “automatically-digitally” and/or “prior-virtually”, since actual access to the facility is no longer even necessary to produce the script according to the present invention. Rather, the configuration script, even before the time of the actual facility configuration, may be generated in preparation merely on the basis of information existing about the facility.

In addition, the method according to the present invention particularly allows the automatable configuration of numerous facilities, even if these facilities are of different types or have different components.

The way in which the script is automatically generated and/or which type of basic components the automatically generated script is compiled from is not primarily essential for the present invention, as long as a configuration script for the particular facility may be generated via the information available about the particular facility. Thus, for example, it is conceivable and possible for the automatic generation of the configuration script to be performed in that the particular suitable commands are removed from a library of individual commands via the information available about the facility and are then automatically compiled into script. Scripts may also, for example, be generated on the basis of automatic comparison of the actual facility configuration to different stored facility configurations and stored scripts or script components suitable for this purpose.

However, according to an especially preferred embodiments of the present invention, the script at least partially comprises script modules, each script module in turn being composed of a number of individual commands and/or possibly setting data. This is especially advantageous in that in this way an automatic assignment may be performed between modular facility components and the command sequences and/or script modules necessary for each modular facility component, which eases, accelerates, and systematizes the compilation of the scripts.

In this case, these script modules, which may be managed and used like systematic modular building blocks, may, for example, be provided by the component manufacturer for the individual facility components, or, for example, they may be tailored or produced by a system administrator. Numerous generally or specially usable individual scripts are often present distributed in a firm in any case, which may thus also be absorbed into the modular script library.

According to a further preferred embodiment of the present invention, the scripts and/or script modules include variable fields, the contents of the fields being changeable, preferably using a parser device. In this way it is possible in particular to change the contents and/or actions of script modules or even of finished scripts later in a targeted way, in that, for example, certain desired command options or certain facility-specific setting data are changed in the script models or in the scripts. In this case, this change in the script modules or scripts is especially preferably performed by a parser device, which may operate according to the “search and replace” principle, for example.

In this way it becomes possible, for example, to configure multiple identical facilities using only one script, fields contained in the script able to be changed previously for each of the facilities individually using the parser device, however. In this way, fine setting and/or fine configuration of individual facilities or all of the facilities to be configured may thus be performed in accordance with special requirements. It is especially advantageous in this case if the field contents may be changed automatically on the basis of information about the component status and/or the operating status of the facility, since in this way, for example, even during a fine configuration or control of this type, only a few or no manual interventions are still necessary.

According to a preferred embodiment of the present invention, scripts, script modules, field contents, and information about the component and/or operating status of the facility are storable in a databank, preferably linked to one another. In this case, the scripts, script modules, and field contents stored in the databank are especially preferably linkable to one another and to features and/or components of the facility and/or to specific actual operating states and/or stored intended operating states of the facility. In this way, it is possible to rapidly and automatically produce an essentially arbitrary number of different configuration and/or control scripts, which are each specially tailored to a specific facility, a specific facility composition, and/or to specific actual-intended differences in the operating state of a specific facility. In this case, the production of these highly specific scripts may also be performed with a high degree of systemization, very reliably, and at high speed, as well as automatically, on the basis of the linkages in the databank.

It is not primarily essential for the present invention how and from what point the execution of the scripts is initiated and/or started. Thus, for example, scripts may be executed locally on a facility, by inserting a data carrier and possibly triggering the start of the script, for example.

According to an especially preferred embodiment of the present invention, configuration or control of the facility and/or start of the script execution is performed like remote operation from a control console. This is especially advantageous in that in this way, not only may the execution of the facility configuration itself and/or the execution of a control cycle of the facility be performed automatically without manual intervention, but in addition the start of the script execution and/or the start of a control sequence or a control cycle may also be performed via the control console at a distance, possibly automatically, without manual hand interventions or inputs at the location of this facility itself still being necessary for this purpose.

According to a preferred embodiment of the present invention, the control console having the databank and the facility may essentially be arbitrarily spatially distant from one another in this case and the script may be transmitted from the control console and/or the databank to the facility for execution.

In this case, according to a further embodiment of the present invention, the script is integrated into a memory image transmittable to the facility, the script especially preferably also being automatically integrated into the memory image. The integration of a configuration or control script into a memory image which may then be transmitted to the facility, where it may be received in a memory of the facility, for example, particularly has the advantage that the script may be integrated into an elementary operating system kernel of the facility in this way and therefore, for example, may be executed automatically when the facility is switched on in order to thus be able to execute operations and/or commands which are especially near the components or hardware.

However, a script integrated into a memory image may just as well also be executed during the normal operation of the facility, the execution of configuration or control scripts using memory images particularly including the advantage that no special control applications or agent programs, which are possibly susceptible to malfunction or are costly, have to be present in the facility or executed there for this purpose. This is connected to a script integrated into a suitable memory image being able to directly access the operating system or the hardware and/or the components of the facility.

According to a further embodiment of the present invention, the control console and facility may also be spatially distant from one another, the script not being transmitted to the facility and executed there, however, but rather the script being executed locally by the control console, also converted there into control commands, and these control commands then being transmitted to the facility. This is especially advantageous if facilities, in which there are no routines for executing scripts or for interpreting commands at the location of the facility itself, but rather they are to be driven and/or controlled directly, for example, electronically, electrically, pneumatically, or hydraulically, are to be controlled by the method according to the present invention.

This relates to, for example, but not exclusively, manufacturing or conveyance facilities in production operations, which may also be configured and/or controlled in this way using the method according to the present invention. It is especially advantageous in this case that a facility controller designed and/or executed in this way may be tailored much more flexibly and individually to the particular existing client requirements than is the case for the known control programs and/or devices for facilities, which are largely bound essentially rigidly to the structure designed by the manufacturer.

Particularly if numerous facilities are to be configured and/or controlled using the method according to the present invention, it is especially important to systematically collect information about the configuration scripts used on the individual machines, for example, and about the particular success and/or results of the individual configuration and/or control steps and to keep this information retrievable. With this background, according to a further embodiment of the present invention, results of the execution of the particular control commands and/or about the execution of scripts or script parts are returned to the control console and/or the databank.

The results returned are especially preferably then linked in a suitable way with the particular facility and/or component identification and/or with the associated scripts, script modules, and/or field contents and stored in the databank for later access. This is especially advantageous in that in this way systematic overviews and/or analyses may be produced, not only about identification and components of the individual facilities, but rather also about the state of the particular configuration of each facility and/or about the instantaneous operating state or about prior operating states. This is of great significance for the efficient central administration and maintenance of the facilities, particularly in environments having numerous identical or different facilities or in firms in which facilities are distributed over multiple locations.

It is not primarily essential for the present invention how the information about the components of a facility and/or about the instantaneous operating status of the facilities, upon which the automatic script production is based, is determined. Thus, for example, it is possible to manually retain the information about the components which the modularly constructed facility, such as a computer server, comprises, during the initial set up or in the form of a device inventory and/or to input it into a databank. However, according to a preferred embodiment of the present invention, information about the components and/or operating status of the facility is determined using automatic component and/or status analysis. In this way, the outlay for manual detection and/or monitoring of the components and/or operating status of a facility may already be decisively reduced.

In this case, the component and/or status analysis is especially preferably controlled from the console. This may be performed, for example, via a special or standardized remote access to the facility, particularly completely automatically via a suitable hardware interface positioned on the facility. According to a further preferred embodiment of the present invention, the component and/or status analysis of the facility is performed automatically at regular intervals. In this way, permanent automatic monitoring of the facility for changes to the facility components and/or for changes to the operating state may advantageously be implemented in particular. The time periods between the regular automatic component and/or status analyses are preferably in the range from fractions of a second to minutes in this case.

This is of decisive importance for server computers in particular, since in this way, after the replacement of a defective component with a replacement part, which requires a different configuration than the original part, however, the server computer may be prevented from being started again without appropriate adjustment of the configuration, since otherwise damage or data losses may occur.

In this way, after changes to the components of a facility, for example, the configuration commands necessary for proper operation of the new components may, on the basis of the automatically determined new configuration and on the basis of information stored in the databank about the new components, be automatically compiled in the form of a configuration script and automatically executed before the facility is put back into operation.

The automation may even go so far in this way that, via the hardware interface, the console automatically remotely identifies a new server computer, which is merely set up and connected to the power supply and data lines, and determines its component structure, then, on the basis of information about the components and about the intended configuration stored in the databank, produces a configuration script from the script modules which are also stored, which is then transmitted to the newly set up server computer and automatically executed there. Through this script execution, the hardware configuration and operating system as well as application installation are executed automatically and the server is finally also automatically connected to the network ready for operation (“rack-and-fire”). In this way, the outlay for the installation and user-specific configuration of a large number of server computers (“deployment”) in a firm may be simplified, accelerated, and reduced in cost by orders of magnitude.

In particular for the new configuration or reconfiguration of facilities, of server computers, for example, it is often necessary to be able to access stored data from the server computer, for example, installation assemblies and data which are stored on external data memories such as a network drive. Often, suitable access rights are necessary to access data of this type, which are typically to be proven using user identification and password. For this purpose, according to the related art, user identifications and passwords are often integrated into automatic configuration or control scripts. However, since this integration according to the related art is often performed in clear text and/or unencrypted, a very significant security risk is connected therewith, since confidential firm data is often also made accessible using these user identifications and passwords. With this background, it is provided according to a further preferred embodiment of the present invention that the script contains user identifications and passwords, user identifications and passwords being integrated into the script in encrypted form, however. In this way, the access to and/or the manipulation of confidential firm data by unauthorized third parties may be prevented with great reliability.

Currently, firms and their production, merchandise, and communication infrastructures often extend over multiple locations which are distant from another. This is particularly true for the communication and data structures of national or international large firms. However, it is typically necessary in this case to ensure location-independent, uniform standards for the operation and maintenance of facilities, particularly of communication and data processing facilities, such as computer servers which are networked with one another. In addition, qualified personnel are necessary for the operation and maintenance of data processing facilities networked in this way, who, for reasons of capacity, may not be available at all times at every firm or facility location in order to configure facilities there or repair malfunctions which have arisen, for example. With this background, it is provided according to a further, especially preferred embodiment of the present invention that the control console is completely operable via an Internet user interface. In this way, it is made possible for the personnel to access the control console, and therefore the configuration, control, and maintenance of the facilities connected to the control console, locally or remotely from nearly any Internet-capable terminal, independent of the time or location.

The way in which the connection and/or the access of the control console to the facilities is produced is not primarily essential according to the present invention in this case, as long as scripts and/or memory images may be transmitted to the facility and/or information about the facility status may be returned to the control console via this access. According to a preferred embodiment of the present invention, however, the access of the control console to the facility is performed via at least one standard interface and/or via a standard protocol language. For a server computer, such a standard interface may be a PCI interface or onboard network interface, via which the hardware and/or the components of the server computer may be accessed directly using PXE images, for example.

According to a further preferred embodiment of the present invention, the control console has interfaces for data and/or command exchange with at least one further facility control device. This may be a control device previously connected to the facility, for example, which is to be used further in parallel in this way besides the additional use of the method according to the present invention and/or besides a use of the control console. In the case of a server computer, the further control device may particularly be an already existing server and/or network administration system, which, in addition to the use of the method according to the present invention, is also to be used for controlling and administrating the computer server.

In such a case, the interface of the control console allows data and command exchange with the existing server and/or network administration application in such a way that either the existing network administration application may now also be operated from the control console or, vice versa, the control console may be operated from the existing network administration application. Which of the alternatives is actually used may be made a function of the preferred mode of operation of the particular user, for example.

In the following, the present invention is described in more detail on the basis of a drawing, which merely illustrates one exemplary embodiment.

The single FIGURE shows an exemplary embodiment of the structure of the method according to the present invention in a schematic block diagram.

In the FIGURE, the databank 1, delimited using dashed lines, may be seen on the left side of the drawing, which may in turn be accessed via a console 2 locally or remotely, via an Internet user interface, for example.

In this case, the method illustrated in the FIGURE, merely for exemplary purposes and highly schematically as a block diagram, is used for automated configuration and/or installation of at least one server computer 3 and/or preferably multiple or numerous networked server computers 3.

It may first be seen in the FIGURE that thanks to the present invention it is possible to completely separate, both spatially and temporally, the procedures necessary for preparing the configuration of a server 2, which may be executed completely in the region of the databank 1, from the actual configuration and/or installation procedure 4. This is made possible in that the databank 1 contains, in a server object and/or memory image 5 of the server hardware 2, all of the information about the server hardware 2 necessary for a configuration 4.

In this case, the information about the server hardware 2 may be input and/or received manually in the databank 1, however, this may also be performed partially or completely automatically using a corresponding hardware recognition 6, illustrated by dotted lines. In this case, automatic hardware recognition particularly allows the server configuration to occur completely automatically after the installation of the server hardware and the connection of the server to the network (“rack-and-fire”).

On the basis of the logical linkages (not shown) present in the databank 1 between the information contained in the server image 5 about the server components and the command sequences and/or script modules 8 necessary for the configuration of the particular server components, the configuration script 7 necessary for configuring the server 2 may now be automatically compiled from the particular script modules 8 assigned to the server components. In this way, still on the “virtual” plane of the databank, even before the actual configuration, a memory image and/or databank object of the completely configured server, called a “system object” 9 here, may be generated. In other words, the system object 9 contains information about both the composition of the server hardware 2 and about the individual script 7 usable and/or used on this server hardware 2, and therefore a detailed and exact image of the concrete server state which the server has after this configuration.

After the preparation of the complete server configuration performed in this way in the region of the databank 1, the actual configuration 4 of the server hardware 2 may then be performed at any arbitrary later point in time. This may occur in that, for example, the prepared script 7 contained in the system object 9 is incorporated into a memory image which may subsequently be transmitted (10) to a distribution server 11 at any arbitrary location in the network. Subsequently, the script 7 stored on the distribution server 11 in the form of the memory image may be transmitted via the network and via a suitable interface to the server 2, written there in the local operating memory of the server 2, for example, and then executed.

The local execution of the configuration script 7 is performed on a server 2 in that, for example, the memory image having the script 7 contained therein for booting the server 2 is used. The script is therefore automatically executed directly after the server 2 is switched on, which may also be remote-controlled through corresponding hardware access (e.g., at 6). Through the command sequences and possibly configuration data contained in the script 7, the entire hardware configuration up to preparation or even up to executing the installation of the server operating system may be performed completely automatically.

In particular, such a completely automatic server configuration 4 may include the hardware settings in the BIOS, the configuration of large memories such as magnetic disks (RAID configuration) and the associated particular documentation.

The documentation of the configuration 4 particularly relates in this case to the log files produced during the individual configuration steps, which each contain information about the success of the individual configuration steps. The documentation is then returned (12) to the databank 1 after completed configuration 4, where it is linked to the server image and/or to the system object 9.

In other words, this means that after completed configuration 4 of the server 2, a very detailed image 9 of the instantaneous configuration state of the server 2 is stored in the databank 1. This is particularly of very decisive importance for reliable and consistent management of server and network structures for large and/or widely distributed information infrastructures, such as those frequently existing in large firms, for example.

In this way it is possible, for example, to provide a system administrator at a central operating location and/or a central control console 2 with a detailed overview of the server configurations 9 existing at various locations, to compare these configurations to one another in a structured way, and, if necessary, to perform the appropriate adjustments, changes, or maintenance work from this same central operating location 2. If capacity expansions in the communication and data structure of a firm make it necessary to increase the number of existing servers 2 as soon as possible and permanently, for example, all of the information necessary for ordering the further servers 2 from the suppliers may even be transmitted directly from the databank 1 to a standard ordering form or system (e.g., SAP), without a manual inventory previously being necessary for this purpose.

As a result, it is clear that it is possible thanks to the present invention to centralize the configuration, control, and maintenance of facilities in a firm as much as possible, particularly complex, extensive, and widely branched server networks, to automate, and simultaneously to very decisively improve the transparency of the configuration state of each individual component of a facility of this type and/or a network of this type. In particular, the outlay necessary for newly configuring or reconfiguring numerous server computers may, thanks to the method according to the present invention, be reduced by orders of magnitude in comparison to the known method, which is essentially based on reproducing static specimen configurations.

1. A method of configuring (4) and/or controlling an electronically controllable, modular facility (3), particularly a server computer (3), the configuration and/or control (4) being performed automatically on the basis of at least one facility-specific script (7),
characterized in that the script (7) is generated automatically on the basis of information about the component and/or operating status of the facility (3).

2. The method according to claim 1,
characterized in that the script (7) comprises script modules (8).

3. The method according to claim 2,
characterized in that the script modules (8) contain variable fields.

4. The method according to claim 3,
characterized in that the fields contained in a script module (8) or in the script (7) are changeable using a parser device.

5. The method according to claim 3 or 4,
characterized in that the fields are automatically changeable on the basis of information about the component and/or operating status of the facility (3).

6. The method according to one of claims 1 to 5,
characterized in that scripts (7), script modules (8), field contents, and information about the component and/or operating status of the facility (3) are storable in a databank (1).

7. The method according to claim 6,
characterized in that scripts (7), script modules (8), and/or field contents are linkable in the databank (1) with facility and/or component identifications and/or with specific actual and/or intended operating status of the facility (3).

8. The method according to one of claims 1 to 7,
characterized in that the configuration (4) is performed from a control console (2) in the form of a remote control.

9. The method according to claim 8,
characterized in that the script (7) is transmitted from the control console (2) and/or from the databank (1) to the facility (3).

10. The method according to one of claims 1 to 9,
characterized in that the script (7) is integrated into in memory image transmittable to the facility (3).

11. The method according to claim 10,
characterized in that the script (7) is automatically integrated into the memory image.

12. The method according to claim 8,
characterized in that the script (7) is executed by the control console (2) and converted into control commands and the control commands are transmitted to the facility (10, 4).

13. The method according to one of claims 1 to 12,
characterized in that results (12) of the execution of the control commands and/or of the script (7) are returned to the console (2) and/or to the databank (1).

14. The method according to claim 13,
characterized in that the results (12) are linked to facility and/or component identifications and/or to script (7), script modules (8), and/or field contents and stored in the databank (1).

15. The method according to one of claims 1 to 14,
characterized in that the information about the component and/or operating status of the facility is determined by an automatically executed component and/or status analysis (6).

16. The method according to claim 15,
characterized in that the component and/or status analysis (6) is controllable from the console (2).

17. Method according to claim 14 or 15,
characterized in that the component and/or status analysis (6) is performed automatically at regular intervals.

18. The method according to claim 17,
characterized in that the intervals are in the range from fractions of a second to minutes.

19. The method according to one of claims 1 to 18,
characterized in that the script (7) contains user identifications and passwords, the user identifications and passwords being encrypted.

20. The method according to one of claims 8 to 19,
characterized in that the control console (2) is operable using an Internet user interface.

21. The method according to one of claims 8 to 20,
characterized in that the control console (2) accesses the facility (3) via at least one standard interface (4, 6).

22. The method according to one of claims 8 to 21,
characterized in that the control console (2) has interfaces for data and command exchange with at least one existing facility control device.
